(19) United States
(12) Patent Application Publication
(10) Pub. No.: US 2016/0366914 A1
(43) Pub. Date: Dec. 22, 2016

(54) PROCESS FOR PRODUCING RICE FRIES COMPRISED OF COOKED VISIBLE RICE-GRAINS FROM TWO TO FOUR SELECTED RICE-GRAIN VARIETIES WHICH AS A MIXTURE PROVIDE CUSTOM-MADE RICE-GRAIN TEXTURES FOR DIVERSE-CULTURE CONSUMERS WHILE OPTIMIZING RICE-GRAIN COHESIVENESS AND FREEZE-THAW PROPERTIES

(71) Applicants: Harold W. Zukerman, Northbrook, IL (US); Rachel B. Zukerman, Northbrook, IL (US)

(72) Inventors: Harold W. Zukerman, Northbrook, IL (US); Rachel B. Zukerman, Northbrook, IL (US)

(21) Appl. No.: 14/743,994

(22) Filed: Jun. 18, 2015

(51) Int. Cl. A23L 1/164

(52) U.S. Cl. CPC A23L 1/1645; A23V 2002/00

(57) ABSTRACT

A process for producing rice fries comprised of cooked visible rice-grains from two to four selected rice-grain varieties, which as a mixture, provide custom-made rice-grain textures for diverse-culture consumers while optimizing the rice-grains cohesiveness and freeze-thaw properties. Every one hundred pounds of predetermined percentages of raw rice-grains from two to four selected rice-grain varieties are cooked with two to three hundred pounds of a cooking-water in a batch-cooker and discharged when they become a viscous, flow-able mixture of partially-cooked visible rice-grains, which have a firmer-texture than fully-cooked rice-grains. Said partially-cooked visible rice-grains from two to four rice grain varieties are distributed through numerous die-plate holes of a low-shear, low-pressure former as numerous, parallel, continuous-strips still comprised of partially-cooked visible rice-grains. Said strips are cut into rice fries shapes which are fat-fried until the rice-grains' defusing-water cooks the firmer-textured, partially-cooked starch-granules in the rice-grain centers and makes them soft and fully-cooked.

### BACKGROUND OF THE INVENTION

Several shaped rice products and processes for preparing them have been described in the prior art:

Southern Regional Laboratories, New Orleans, La. teaches a process whereby finely-milled rice flour is hydrated and extruded into low-moisture, homogeneous-consistency textured rice fries which are then fat-fried.

In U.S. Pat. No. 3,711,295, a procedure is disclosed for making a shaped rice product with broken-grain rice grains that have an interior which is described on Page 2 line 13 as: “interior 22 appears to have a homogeneous-consistency when examined under the microscope.”

In U.S. Pat. No. 3,061,087, a procedure is described for cooking and starch-complexing rice.

In U.S. Pat. No. 4,764,390, a process is described for preparing shaped rice products designed to be fully-cooked in the consumers' home microwave ovens. Said uncooked shaped rice products are not suitable for pop-up toasters because their surfaces burn before the products' interiors are cooked.

In U.S. Pat. No. 5,137,745 a process is described for cooking several different cereal grain genera such as rice, wheat and oats to make fully-cooked grain-cups and grain carriers. The '745 patent teaches a process for cooking the different grain genera in a sequence. Whole-grain oats (which require a 90 minute cook-time) are added first. Then, raw, steel-cut wheat (which requires a 50 minute cook-time) are added 40 minutes later. Twenty minutes later long grain rice grains are added. When this sequence is followed, all three grain genera become fully-cooked at the same time and are discharged from the cooker and are used to make the grain-cups and grain-carriers.

The process in U.S. Pat. No. 6,767,570 B2 teaches how to make shaped rice products that have homogeneous-consistency textures. To be more specific, the rice grains of the '570B2 patent are infused with extra-water to replace the water lost by evaporation when the products are later fat-fried. This extra water makes the fully-cooked rice grains extra-soft and water-bloated and they are not able to withstand the shaping operation, and as a result fracture and are deposited as fractured rice grains which look-like a homogeneous-consistency texture.

In contrast, the process of the present invention is designed to retain fully-cooked, visible, mixed rice grains (comprised of two to four rice grain varieties) in the finished product texture. This is achieved by first cooking and then redepositing a mixture of firmer-textured, partially-cooked visible rice-grains from two to four rice grain varieties through numerous die-plate holes of a low-shear, low-pressure former as parallel, continuous-strips still comprised of firmer-textured partially-cooked visible rice-grains. Said partially-cooked rice grains are used because they have firmer-textures than soft-textured, water-bloated, fully-cooked rice grains and are therefore better able to withstand the shaping operation without fracturing rice grains. Rice fries shapes are then fat-fried to develop thin-skins and are removed from the frying fat when the firmer-textured starch-granules in the grain-centers become soft and fully-cooked with the rice grains' defusing water.

The present invention teaches making rice fries comprised of cooked visible rice grains from two to four selected rice grain varieties, which as a mixture, provide custom-made rice grain-textures for diverse-culture consumers while also optimizing the rice fries' grain-cohesiveness and freeze-thaw properties. Two to four rice grain varieties are needed because one rice-grain variety cannot provide all the properties. For example, American consumers enjoy eating cooked long grain rice-grains because they provide “mealy-textures.” The problem is the individual cooked long-grain rice grains remain as separate rice grains, that is, they don't stick to one another. Also, rice fries made with long-grain rice grains are comparatively high in amylose-starch (straight chain polymer of D-glucose units) which retrograde and shrink in size when the rice fries are stored frozen. In the process of the present invention, rice fries made for American consumers are made with two to three rice grain varieties. The primary rice grain variety is long grain rice grains which provide “mealy-texture.” In addition, smaller amounts of medium-grain and/or short-grain rice grains are also used in the formulation because they have a large amount of amylopectin-starch (branched chain polymer of D-glucose units) which provide extra grain-cohesiveness (stickiness) which bind the grains to one another and improved freeze thaw stability properties.

As a second example Asian consumers enjoy eating rice fries made with two rice grain varieties: medium-grain and short-grain rice grains because they enjoy eating sticky-pasty textured rice grains. Medium-grain and short-grain rice grains also provide grain-cohesiveness and freeze-thaw stability properties.

### BRIEF SUMMARY OF THE INVENTION

The present invention relates to a process for producing rice fries comprised of thin skins enclosing fully-cooked visible rice-grains from two to four selected rice-grain varieties which as a mixture, provide custom-made rice-grain textures for diverse-culture consumers while optimizing the rice fries' cohesiveness and freeze-thaw properties; said process comprising the steps of: a) cooking every one hundred pounds of predetermined percentages of raw rice-grains from two to four selected rice-grain varieties with two to three hundred pounds of cooking-water in a batch-cooker and discharging them when they become a viscous, flow-able mixture of partially-cooked visible rice-grains from two to four selected rice grain varieties which have a firmer-texture than fully-cooked rice-grains; b) distributing without fracturing said mixture of firmer-textured, partially-cooked visible rice-grains through numerous die-plate holes of a low-shear, low-pressure former into numerous parallel continuous-strips and cutting them into rice fries' shapes; c) fat-frying said rice fries shapes until the rice grains' defusing water cooks the starch-granules in the firmer-textured, partially-cooked grain-centers and makes them soft and fully-cooked. If desired, the fat fried rice fries can be frozen.

It is the primary object of the present invention to make rice fries comprised of cooked visible rice grains from two to four selected rice grain varieties, which as a mixture, provide custom-made rice grain-textures for diverse-culture consumers while also improving the rice fries' grain-cohesiveness and freeze-thaw properties.

It is another object of the present invention to make rice fries comprised of a mixture of fully-cooked visible rice grains from two to four rice grain varieties which are formed with firmer-textured, partially-cooked visible rice-grains that become soft and fully-cooked when the rice fries are fat fried or oven baked at the end of the process.

### DETAILED DESCRIPTION OF THE PREFERRED EMBODIMENT

The present invention relates to a process for producing rice fries comprised of thin skins enclosing fully-cooked visible rice-grains from two to four selected rice-grain varieties which as a mixture, provide custom-made rice-grain textures for diverse-culture consumers while optimizing the rice fries' cohesiveness and freeze-thaw properties; said process comprising the steps of: a) cooking every one hundred pounds of predetermined percentages of raw rice-grains from two to four selected rice-grain varieties with two to three hundred pounds of cooking-water in a batch-cooker and discharging them when they become a viscous, flow-able mixture of partially-cooked visible rice-grains from two to four selected rice grain varieties which have a firmer-texture than fully-cooked rice-grains; b) distributing without fracturing said mixture of firmer-textured, partially-cooked visible rice-grains through numerous die-plate holes of a low-shear, low-pressure former into numerous parallel continuous-strips and cutting them into rice fries' shapes; c) fat-frying said rice fries shapes until the rice grains' defusing water cooks the starch-granules in the firmer-textured, partially-cooked grain-centers and makes them soft and fully-cooked. If desired, the fat fried rice fries can be frozen.
Note: Raw whole rice-grains are as hard as stones. When raw rice-grains are cooked in water, the water from the cooker is continuously absorbed into the rice-grains' surface areas and then said infused-water slowly defuses through the grains' interiors and towards the grains' uncooked centers. Rice-grains with un-cooked centers are considered to be partially-cooked rice-grains and have textures that are firmer than fully-cooked rice-grains and are therefore better able to withstand the compression-shaping operation without fracturing. Fat-fried rice fries can be frozen.

It is within the scope of the present invention to slightly modify the process to make low-fat fat-fried rice fries and also low-fat oven-baked rice fries, both of which are comprised of a mixture of two to four rice-grain varieties.
1. Fat-fried low-fat rice fries: Rice fries shapes are fat-fried for less than two minutes at about 400° F. to develop thin-skins, removed from the frying-fat, and further-heated outside the fryer at temperatures higher than 180° F. until the firmer-textured, partially-cooked rice-grains become soft and fully-cooked with the grains' defusing water.
2. Oven-baked low-fat rice fries: Rice fries shapes are oven-baked at temperatures between 375° F. and 475° F. in a convection-oven and discharged when the rice fries' firmer-textured partially-cooked visible rice-grains become soft and fully-cooked with the rice grains' defusing water.

Additional details of the process for producing rice fries comprised of cooked, visible rice grains from two to four selected rice-grain varieties, which as a mixture, provide custom-made rice-grain textures for diverse-culture consumers while improving the rice fries' cohesiveness and freeze-thaw properties, are listed below:

The rice fries of the present invention are custom-made with two to four selected rice-grain varieties chosen from the approximately 40,000 different rice-grain varieties grown throughout the world and are marketed by grain-size and the country in which they are grown. For example, long-grain rice-grains grown in the United States are marketed as US long-grain rice-grains, whereas, short-grain rice-grains grown in Japan are marketed as Japanese short-grain rice-grains. It needs to be understood that although the different rice-grain varieties are marketed by size, they actually differ in physical properties, such as texture, taste, and different amylose to amylopectin-ratios which affect the rice-grains' cohesiveness and freeze-thaw properties. In the products of the present invention, at least two rice-grain varieties are needed because one rice-grain variety provides the custom-made rice-grain texture for the specific consumer group while a second rice-grain variety improves the rice-grain cohesiveness and freeze-thaw properties. Differences between the US rice-grain varieties are as follows:

US long-grain rice-grains are 3 to 5 times as long as they are wide. They have 19% to 23% amylose (straight chain polymer of D-glucose units), 77% to 81% amylopectin (branched chain polymer of D-glucose units) and provide mealy-textures. Cooked long-grain rice-grains do not stick to one another and are not freeze-thaw stable.

US medium rice-grains are 2 to 3 times as long as they are wide. They have 12% to 19% amylose and 81% to 88% amylopectin and provide pasty-mealy textures. Cooked medium-grain rice-grains have more grain cohesiveness and more freeze-thaw stability properties than long-grain rice-grains.

US short-grain rice-grains are as long as they are wide. They have 12% to 19% amylose and 81% to 88% amylopectin and provide pasty-sticky-textures and good grain-cohesiveness and freeze-thaw stability properties.

US waxy rice-grains are 100% amylopectin starch and have good grain-cohesiveness and freeze-thaw stability.
Note: Rice grains are comprised of two kinds of starch: 1) amylose-starch (straight chain polymer of D-glucose units) and 2) amylopectin-starch. The long-grain and medium-grain rice-grains provide a larger amount of amylose-starch which provide “mealy” rice-grain textures; whereas, the short-grain rice-grains have a larger amount of amylopectin-starch (branched chain polymer of D-glucose units) which provide “pasty-sticky” rice-grain textures.

In this invention, the selected rice-grains are cooked with water in a tilt-type batch-cooker. At the end of the cooking step, the entire-batch is discharged when the grains become a viscous, flow-able mixture of partially-cooked visible rice-grains, which are firmer in texture than fully-cooked rice-grains.

The cooking-water added to the tilt-type batch-cooker can be heated with an in-line heat-exchanger or in a separate kettle. The following ingredients from the group consisting food flavors, food colors, dextrose, salt, sugar, vegetable oil, herbs, spices, dry-milk solids, diced and sliced garlic, onions, scallions, peppers, eggs, chicken, meat, pork, sea-food, fruit, food-particles, and combinations thereof can be added to the water in a separate kettle before transferring said cooking-water to the batch-cooker. Starch-complexing agents such as monoglycerides which prevent retro-gradation, lecithin, and disodium-dihydrogen pyrophosphate that chelates trace metals can also be added to and mixed with the heating water in the separate kettle.

Raw rice-grains as a mixture of two to four rice-grain varieties and cooking-water can be cooked in a continuous-cooker. When a continuous-cooker is used, raw rice-grains and cooking-water are metered into a continuous-cooker, cooked together and discharged from the cooker when they become a viscous, flow-able mixture of partially-cooked visible rice-grains, which have a firmer-texture than fully-cooked rice grains.

The prior art patents teach that rice-grains made for shaped rice products are fully-cooked before they are formed into rice fries shapes. Our tests show that because the fully-cooked rice-grains have to be infused with extra-water to replace the water lost by evaporation when the products are later fat-fried, they become too soft and water-bloated to withstand the shaping operation, and as a result fracture and are deposited as fractured rice grains which look-like a homogeneous-consistency texture.

The process of the present invention uses a different process which retains the fully-cooked visible rice grains in the finished product. This is achieved by extruding firmer-textured, partially-cooked, visible rice-grains through numerous die-holes, of any size and shape larger than one-eighth inch, with a low-shear, low-pressure two-roll former and depositing them as parallel, continuous-strips of firmer-textured, partially-cooked, visible rice-grains. To achieve minimum pressure in the former, the die-plate should have a maximum number of holes larger than ⅛ inch and a minimum space between said holes.

In the process of the present invention, rice fries are custom-made with two to four rice-grain varieties in order to satisfy diverse-culture rice consumers and to optimize the rice fries' cohesiveness and freeze-thaw properties.

TABLE 1
Application of Principles of the Present Invention

| | American | American | | |
|---|---|---|---|---|
| | Consumers | Consumers | Asian Consumers | Asian Consumers |
| | Example 1: Two | Example 2: Four | Example 3: Two | Example 4: Four |
| | Rice Grain | Rice Grain | Rice Grain | Rice Grain |
| | Varieties | Varieties | Varieties | Varieties |
| Selected Rice Grain Varieties | Percent | Percent | Percent | Percent |
| US Long Grain Rice Grains | 50 | 50 | 0 | 10 |
| US Medium Grain Rice Grains | 50 | 30 | 0 | 30 |
| US Short Grain Rice Grains | 0 | 10 | 50 | 30 |
| Japanese Short Grain Rice Grains | 0 | 10 | 50 | 30 |
| Totals | 100 | 100 | 100 | 100 |

Note:
Different rice grain varieties and different percentages of each rice grain variety can be used to make rice fries without departing from the spirit and scope of the invention.

Example 1 shows a formula that can be used for making rice fries for American consumers. This formula uses two rice-grain varieties: 50% US long-grain and 50% US medium-grain rice-grains, which as a mixture, provide mealy-textured rice fries and greatly optimized rice-grain-cohesiveness and freeze-thaw stability properties.
Example 2 shows a second formula that can also be used for making rice fries for American consumers. This formula uses four rice-grain varieties: 50% US long-grain, 30% US medium-grain, 10% US short-grain and 10% and Japanese short-grain rice-grains, which as a mixture, also provide mealy-textured rice fries and greatly optimized rice-grain-cohesiveness and freeze-thaw stability properties.
Example 3 shows a formula that can be used for making rice fries for Asian consumers. This formula uses two rice-grain varieties: 50% Japanese short-grain rice-grains and 50% US medium-grain rice-grains which, as a mixture, provide mealy-pasty textured rice fries and improved grain-cohesiveness and freeze-thaw stability properties.
Example 4 shows a second formula used for making rice fries for Asian consumers. This formula uses four rice-grain varieties: 30% US medium-grain rice-grains, 30% Japanese short-grain rice-grains, 30% US short-grain, and 10% US long-grain which as a mixture, provide pasty-textures, grain-cohesiveness and freeze-thaw properties.

The process of the present invention makes rice fries shapes with partially-cooked rice grains which have textures that are firmer than fully-cooked rice grains. Firmer-textured partially-cooked rice grains are able to withstand the shaping operation needed to make rice fries without fracturing, whereas, very-soft fully-cooked water-bloated, rice grains completely-fracture and change into a homogeneous-consistency texture.

The rice-grains of the present invention are water-bloated because they are infused with a large amount of extra-water needed to replace water lost by evaporation when the rice fries are fat-fried. This extra-water makes the fully-cooked rice-grains extra soft and water-bloated. The problem is fully-cooked, water-bloated, rice-grains fracture and become deposited as a homogeneous-consistency rice texture instead of cooked visible rice-grains.

In contrast, the process of the present invention is designed to retain fully-cooked, visible, mixed rice-grains comprised of two to four rice-grain varieties in the finished product texture. This is achieved by first cooking and then distributing a mixture of firmer-textured, partially-cooked visible rice-grains from two to four rice grain varieties through numerous die-plate holes of a low-shear, low-pressure former as parallel, continuous-strips still comprised of firmer-textured partially-cooked visible rice-grains. Said partially-cooked rice grains are used in this application because they have firmer-textures than soft-textured, water-bloated, fully-cooked rice grains and are better able to withstand the shaping operation without fracturing and without changing the visible rice grains into a homogeneous-consistency. Rice fries shapes are then fat-fried to develop thin-skins and are removed from the frying fat when the firmer-textured starch-granules in the grain-centers become soft and fully-cooked with the rice grains' defusing water.

The following two formulas have two or more rice-grain varieties, which as a mixture provide custom-made textures for different consumer groups while optimizing rice fries grain-cohesiveness and freeze-thaw properties.
Formula 1: Rice Fries Made With Three US Rice Grain Varieties For American Consumers:

| Ingredients | Percent |
|---|---|
| Water | 70.0 |
| (US) Long-grain white rice grains | 10.0 |
| (US) Medium-grain white rice grains | 10.0 |
| (US) Short Grain Rice Grains | 4.0 |
| Onion flavor* | 6.0 |
| Totals | 100.0 |

### Contains: Dehydrated Onions, Dextrose, MSG, Butter, Salt, Monoglycerides, Disodium Dihydrogen Pyrophosphate.

Formula 2: Rice Fries Made With Two Rice Grain Varieties For Asian Consumers

| Ingredients | Percent |
|---|---|
| Water | 68.0 |
| (Japanese) Short-Grain white rice grains | 12.0 |
| (US) Medium-Grain white rice grains | 12.0 |
| Asian Seasonings* | 8.0 |
| Total | 100.0 |

### Contains: Cooked Rice, Asian Seasoning, Dextrose, Salt, Monoglycerides, Disodium Dihydrogen Pyrophosphate.

It is understood that the above described process and the above described examples are simply illustrative of the application of principles of the invention and many other modifications may be made without departing from the spirit and scope of the invention. The embodiments of the invention in which an exclusive property or privilege is claimed are defined as follows:

We claim:

1. A process for producing rice fries comprised of thin skins enclosing fully-cooked visible rice-grains from two to four selected rice-grain varieties; said process comprising the steps of:
a) cooking every one hundred pounds of predetermined percentages of raw rice-grains from two to four selected rice-grain varieties with two to three hundred pounds of cooking-water in a batch-cooker and discharging them when they become a viscous, flow-able mixture of partially-cooked visible rice-grains from two to four selected rice grain varieties which have a firmer-texture than fully-cooked rice-grains;
b) distributing, without fracturing, said mixture of firmer-textured, partially-cooked visible rice-grains of 1a) through numerous die-plate holes of a low-shear, low-pressure former into numerous parallel continuous-strips and cutting them into rice fries' shapes;
c) fat-frying said rice fries shapes of 1b) until the rice grains' defusing water cooks the starch-granules in the firmer-textured, partially-cooked grain-centers and makes them soft and fully-cooked.

2. The process set forth in claim 1 wherein the selected two to four rice grain varieties are chosen from the group consisting of about 40,000 rice grain varieties which are grown throughout the world and are internationally marketed by both the countries in which they are grown and their grain-size: long-grain, medium grain, short-grain, and waxy rice grains.

3. The process set forth in claim 1 whereby the cooking-water is water.

4. The process set forth in claim 1 which further comprises heating and mixing the cooking-water in a separate kettle before transferring said cooking-water to the batch-cooker.

5. The process set forth in claim 4 which further comprises adding to the heating and mixing water in the separate kettle, ingredients selected from the group consisting of: food flavors, food colors, dextrose, salt, sugar, vegetable oil, herbs, spices, dry-milk solids, diced and sliced garlic, onions, scallions, peppers, eggs, chicken, meat, pork, sea-food, fruit, food-particles, and combinations thereof before transferring said cooking-water to the batch-cooker.

6. The process set forth in claim 4 which further comprises adding to the heating and mixing water in a separate kettle, chemicals selected from the group consisting of: starch-complexing agents, lecithin, sodium-dihydrogen pyrophosphate and combinations thereof before transferring said cooking-water to the batch-cooker.

7. The process set forth in claim 1 whereby the cooker is a tilt-type batch-cooker that cooks the rice-grains and cooking-water in an upright position and when tilted 90 degrees, dumps the entire batch of partially-cooked visible rice-grains.

8. The process set forth in claim 1 which further comprises cooking said mixture of raw rice-grains and cooking-water in a continuous-cooker, whereby both the raw rice-grains, as a mixture of two to four rice-grain varieties, and cooking-water are metered into the continuous-cooker at a constant rate, cooked and mixed together in said continuous-cooker and then discharged as a viscous, flow-able mixture of partially-cooked visible rice-grains.

9. The process set forth in claim 1 whereby the former is a low-pressure, low-shear two-roll former equipped with a die-plate having any size ore shape holes that are ⅛ inch or larger;

10. The process set forth in claim 1 which further comprises making low-fat rice fries by fat-frying the rice fries shapes for less than two minutes at about 400° F. to develop thin-skins and then removing the rice fries from the frying-fat and further heating them outside the fryer at temperatures higher than 180° F. until the rice fries' firmer-textured, partially-cooked visible rice-grains become soft and fully-cooked with the rice-grains' defusing water.

11. The process set forth in claim 1 which further comprises freezing the fat-fried rice fries.

12. A process for producing rice fries comprised of thin skins enclosing fully-cooked visible rice-grains from two to four selected rice-grain varieties; said process comprising the steps of:
12a) cooking every one hundred pounds of predetermined percentages of raw rice-grains from two to four selected rice-grain varieties with two to three hundred pounds of cooking-water in a batch-cooker and discharging them when they become a viscous, flow-able mixture of partially-cooked visible rice-grains from two to four selected rice grain varieties which have a firmer-texture than fully-cooked rice-grains;
12b) distributing without fracturing said mixture of firmer-textured, partially-cooked visible rice-grains of 12a) through numerous die-plate holes of a low-shear, low-pressure former into numerous parallel continuous-strips and cutting them into rice fries' shapes;
12c) oven-baking said rice fries shapes of 12b) until their rice grains' defusing water cooks the starch-granules in the firmer-textured, partially-cooked grain-centers and they become soft and fully-cooked.

13. The process set forth in claim 12 wherein the selected two to four rice grain varieties are chosen from the group consisting of about 40,000 rice grain varieties which are grown throughout the world and are internationally marketed by both the countries in which they are grown and their grain-size: long-grain, medium grain, short-grain, and waxy rice grains.

14. The process set forth in claim 12 which further comprises heating and mixing the cooking-water in a separate kettle before transferring said cooking-water to the batch-cooker.

15. The process set forth in claim 14 which further comprises adding to the heating and mixing water in the separate kettle, ingredients selected from the group consisting of: food flavors, food colors, dextrose, salt, sugar, vegetable oil, herbs, spices, dry-milk solids, diced and sliced garlic, onions, scallions, peppers, eggs, chicken, meat, pork, sea-food, fruit, food-particles, starch-complexing agents, lecithin, sodium-dihydrogen pyrophosphate and combinations thereof before transferring said cooking-water to the batch-cooker.

16. The process set forth in claim 12 whereby the cooker is a tilt-type batch-cooker that cooks the rice-grains and cooking-water in an upright position and when tilted 90 degrees, dumps the entire batch of partially-cooked visible rice-grains.

17. The process set forth in claim 12 which further comprises cooking said mixture of raw rice-grains and cooking-water in a continuous-cooker, whereby both the raw rice-grains, as a mixture of two to four rice-grain varieties, and cooking-water are metered into the continuous-cooker at a constant rate, cooked and mixed together in said continuous-cooker and then discharged as a viscous, flow-able mixture of partially-cooked visible rice-grains.

18. The process set forth in claim 12 whereby the former is a low-pressure, low-shear two-roll former equipped with a die-plate having any size ore shape holes that are ⅛ inch or larger;

19. The process set forth in claim 12 which further comprises making low-fat rice fries by oven-baking the rice fries shapes at temperatures between 375° F. and 475° F. until the rice fries' firmer-textured, partially-cooked visible rice-grains become soft and fully-cooked with the rice-grains' defusing water.

20. The process set forth in claim 12 which further comprises freezing the oven-baked rice fries.
